(19) United States
(12) Patent Application Publication
(10) Pub. No.: US 2018/0170271 A1
(43) Pub. Date: Jun. 21, 2018

(54) Ladder Rack Belt is an apparatus to secure Extension and Step Style Ladders to any general-purpose overhead ladder rack for Transportation

(71) Applicants: Mark Rutledge Garofano, Syracuse, NY (US); Jose Leobel Bosque, Jacksonville, FL (US)

(72) Inventors: Mark Rutledge Garofano, Syracuse, NY (US); Jose Leobel Bosque, Jacksonville, FL (US)

(21) Appl. No.: 15/379,679

(22) Filed: Dec. 15, 2016

(51) Int. Cl. B60R 9/048; B60P 7/06; F16B 2/08

(52) U.S. Cl. CPC B60R 9/0485; F16B 2/08; B60P 7/06

(57) ABSTRACT

A Locking/Tightening mechanism to secure Extension and Step Style Ladders to any general-purpose overhead ladder rack for transportation. The apparatus creates an enclosed system by contouring to the ladder rail or steps and provides a one-way mating Terminal Buckler at the end of its enclosed Belt thereby locking the Ladders securely to the Ladder Rack cross rails.

### CROSS-REFERENCE TO RELATED APPLICATIONS

This is a Non-Provisional patent application relating to provisional patent No. 62/386,967 filed on Dec. 18, 2015

The Ladder Rack Belt is an apparatus to secure Extension and/or Step Style Ladders to any general-purpose overhead Ladder rack for Transportation. It consists of three parts: The Locking/Tightening mechanism, the Belt or Strap that affixes and secures the ladders to the rack and the Terminal Buckle that fits (interlocking securely) into the locking/tightening mechanism.

### ELEMENTS OF THE SPECIFICATION

### Background of the Invention

Every year, on frequent time intervals, there are vehicle accidents and/or personal injury accidents around the world leading to injury and deaths of individuals because of Extension and Step Ladders falling off Trucks, Vans, and Trailers. In some cases, it is the ladder transport vehicle driver being injured or killed by other vehicles while attempting to retrieve their ladder(s) from the roadway or the fallen ladder being the cause in turn of other vehicles colliding with one another and/or the ladder(s) in the roadway. In some cases, the Ladders do not inadvertently fall from the vehicle transporting them but rather are ejected in an accident for other reasons which often creates additional “chain reaction” accidents.

Regardless of the device in use the failure (Ladders passively falling off or being ejected) mode assumptions are perceived as:
1. Forward ejection where the ladders eject or come off the front side of the vehicle
2. Rear ejection where the ladders eject or come off the back side of the vehicle
3. Side ejection where the ladders eject, often flipping, or come off one or the other of the two sides of the vehicle
4. Upward projection as the result of a transport vehicle being involved in a multi-vehicle accident

Existing general purpose device perceived shortcomings and failure modes are related to:
1. Terminal end connections becoming dislodged (particularly during an accident)
2. Ladder movement from its/their existing secured position that “relaxes” the securement device tension
3. Material failure
4. Inadequate retention strength securing a “stack” of multiple ladders upon each other
5. Devices “looping” over a transported Ladder rather than through a rung “cavity”

It is worth noting that the general-purpose Rubber type Bungle Cords are quite commonly used and their unique failure mode, in that their material properties change over time as they are not UV stable, is that the “hooks” rip out of the strap grommet as the material “dries” over time and when the vehicle suddenly stops, or is struck, or is swerving, in an accident scenario.

The average employee working in many of these trades are not as safety oriented as they perhaps should be and thus are not considering the potential result of the damages that could be caused because of their carelessness. Many times, to get to the next job site quickly these types of workers are not taking the time necessary to properly secure their ladders

Such a device that provides for the consistent “mistake proof” safer and more reliable way of transporting Ladders on general purpose overhead racks might even be mandated someday (like seat belts, child safety seats, etc) by Transportation Authorities. Additionally, perhaps there may be insurance carrier discounts offered to “multi-truck” commercial fleets like ABS Brake and Passive Alarm System discounts are provided for now if a proven product existed that could not be used incorrectly and possessed redundant safety characteristics.

### BRIEF SUMMARY OF THE INVENTION

The invention consists of a locking/tightening mechanism to keep ladders from falling off and causing accidents with loss of life and/or property damages while being transported. The Ladder Rack Belt apparatus is easy to use and mistake proof. It creates a closed system that conforms to the shape of the ladder and the rack to keep them from coming loose and falling off. The purpose of the ladder rack belt apparatus is foremost to protect users transporting ladders from causing loss of life and/or property damage due to ladders coming loose and falling on the roadway.

### BRIEF DESCRIPTION OF DRAWINGS

A complete understanding of the present invention may be obtained by reference to the accompanying drawings, when considered in conjunction with the subsequent detailed description, in which:

FIG. 1 is a front perspective view of the apparatus

FIG. 2 is a rear perspective view of the apparatus shown in FIG. 1

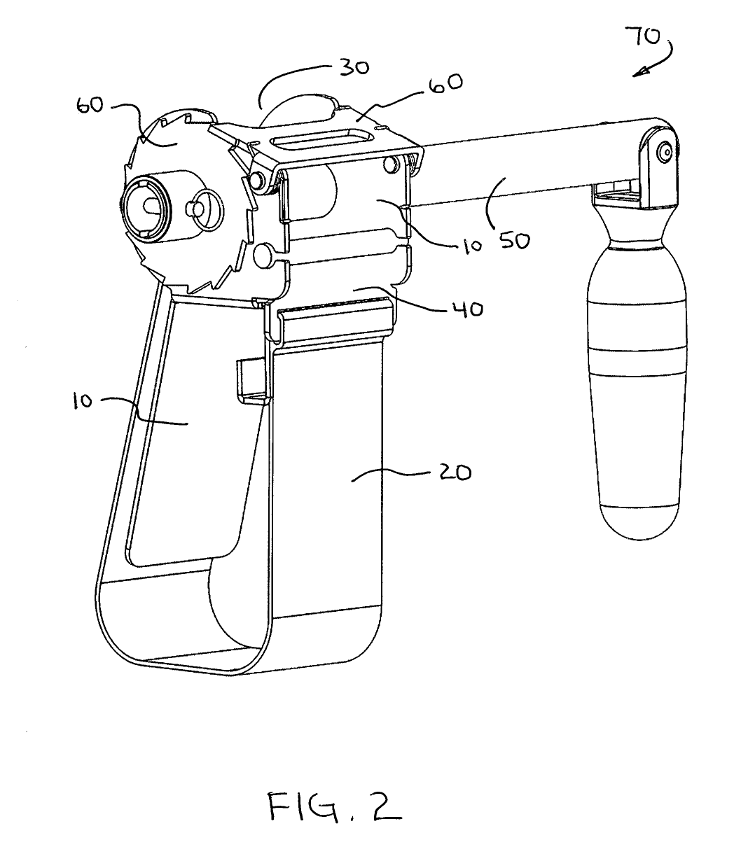

FIG. 3 is a side perspective view of the apparatus shown in FIG. 1 in place on an extension style ladder

FIG. 4 is a side perspective view of the apparatus shown in FIG. 1 in place on a step style ladder

FIG. 5 is a detailed perspective view of the apparatus terminal buckle in FIG. 1 as it enters the apparatus Locking/Tightening Mechanism and before it is secured by the Belt or Strap

FIG. 6 is a detailed perspective view of the apparatus terminal buckle in FIG. 1 as it has passed completely into the apparatus Locking/Tightening Mechanism and before it is secured by the Belt or Strap

FIG. 7 is a front perspective view of an alternative apparatus

FIG. 8 is a front perspective view of another alternative apparatus

### DETAILED DESCRIPTION OF THE PREFERRED EMBODIMENT

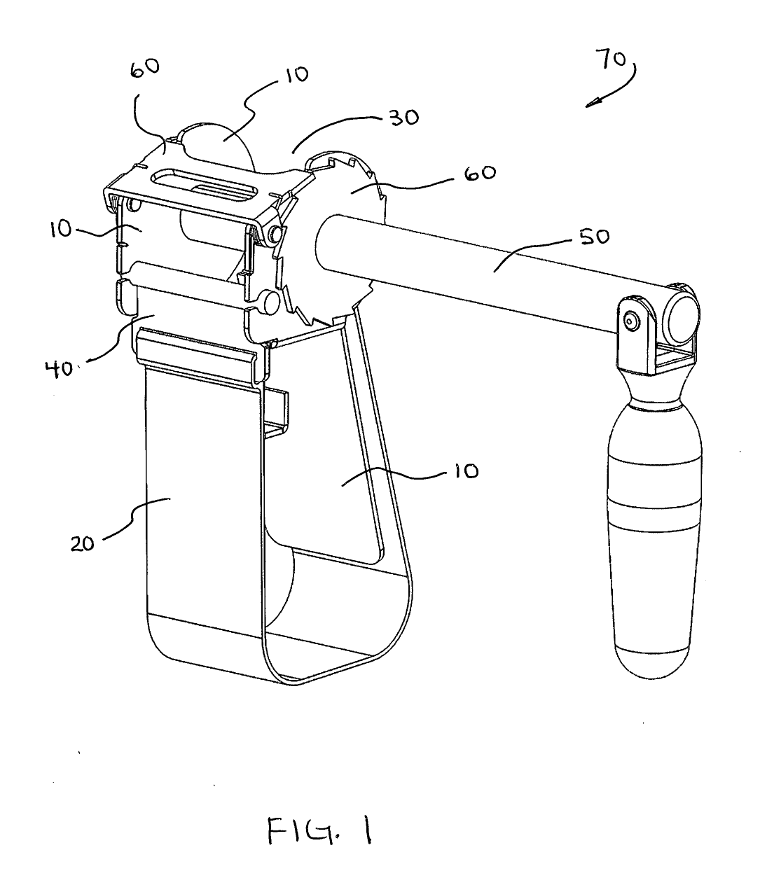

Referring to FIG. 1 as it illustrates an exemplary embodiment of an apparatus 70 that can secure either, or both, extension or step style ladders while in transportation on a vehicle. These embodiments include a locking/tightening mechanism bracket member 10 that in its profile is complimentary to mate up to the prescribed angle form of both extension or step style ladders and is attached in such a way so as to apply a direct downward force to the vehicle cross member when combined in its use with an adjustable length belt or strap 20 dispensed from a spooled cassette member 30 and secured with a terminal buckle 40 that is connected back to the locking/tightening mechanism bracket member 10 before tension is applied via the rotating shaft member 50 and its progressive shaft spooling take up tightening device 60 to secure either extension or step style ladders, or a combination formed by stacking them vertically upon one another, before they are transported.

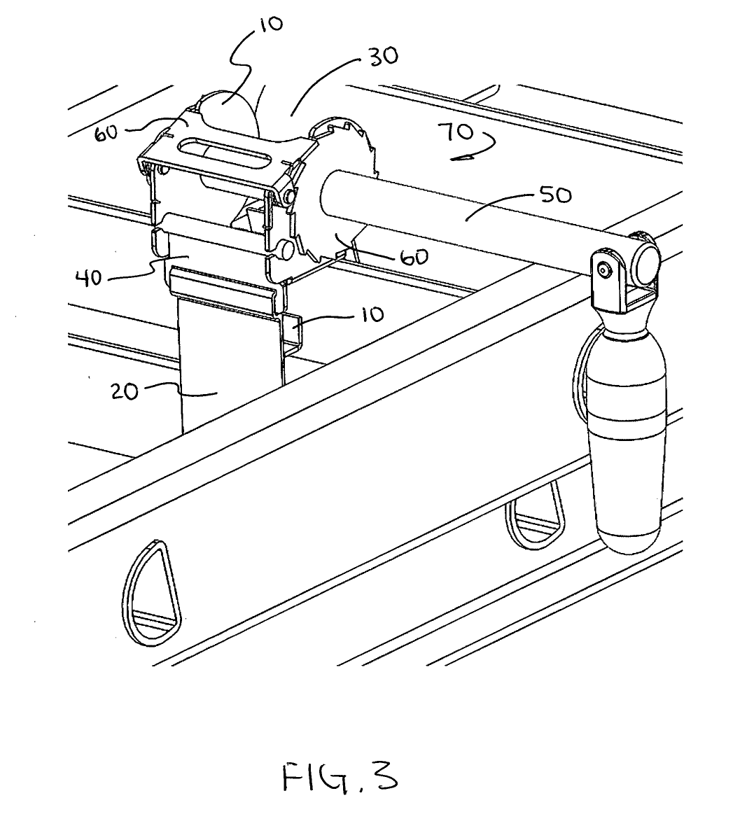

Referring to FIG. 3 as it illustrates an exemplary embodiment of an apparatus 70 as it is depicted “in place” on an extension style ladder showing its conformity to that step member to the shape of the locking/tightening mechanism bracket member 10.

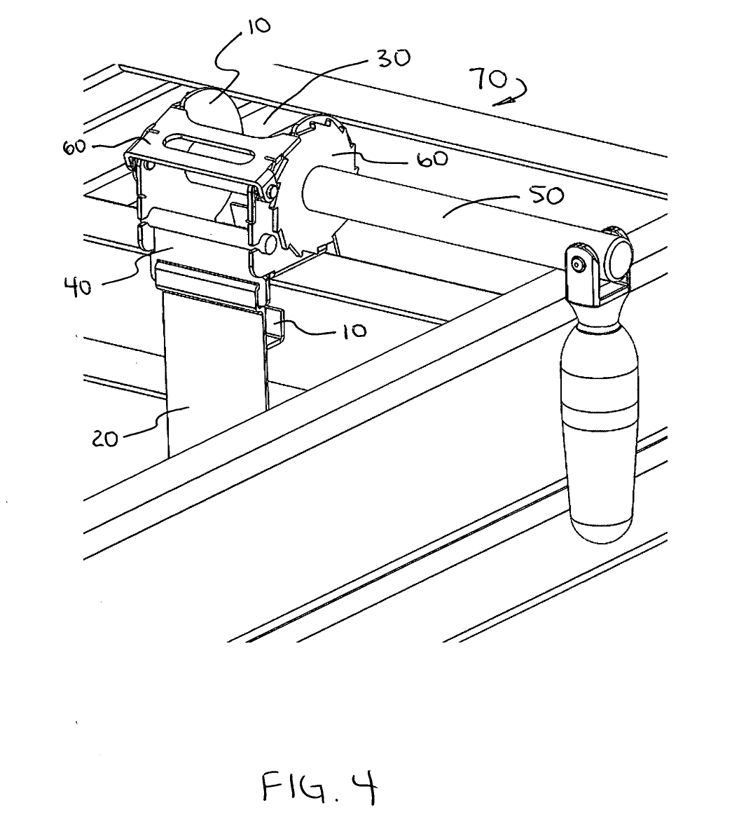

Referring to FIG. 4 as it illustrates an exemplary embodiment of an apparatus 70 as it is depicted “in place” on a step style ladder showing its conformity to that step member to the shape of the locking/tightening mechanism bracket member 10.

Broadly, embodiments of the apparatus prevent the user from securing either extension or step style ladders via any other means than applying an adequate and relatively centralized downward force to the stated vehicle cross member so as to prevent them from moving fore or aft or into axial rotation relative to the vehicle and potential ejection from the vehicle during their routine transportation and particularly during an accident event.

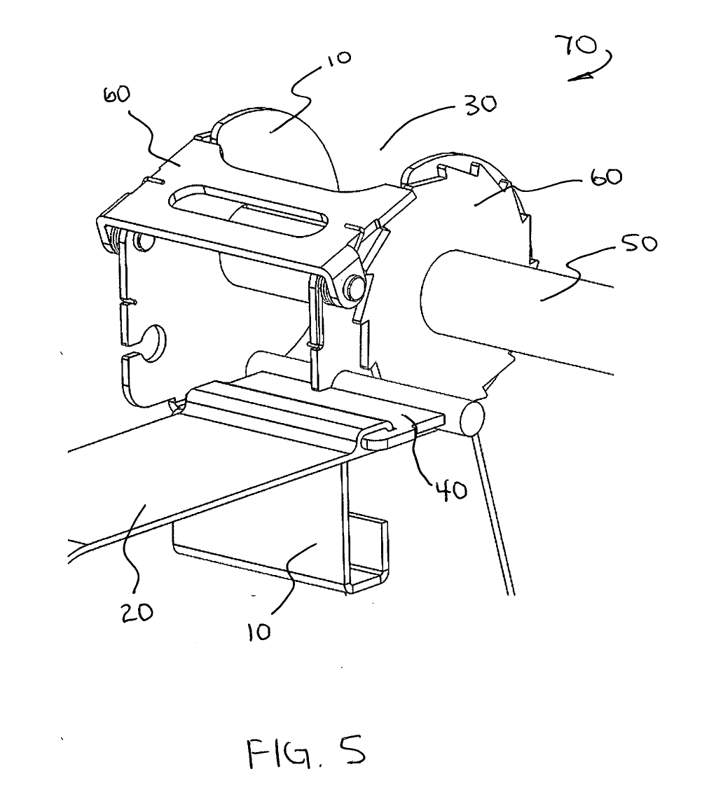

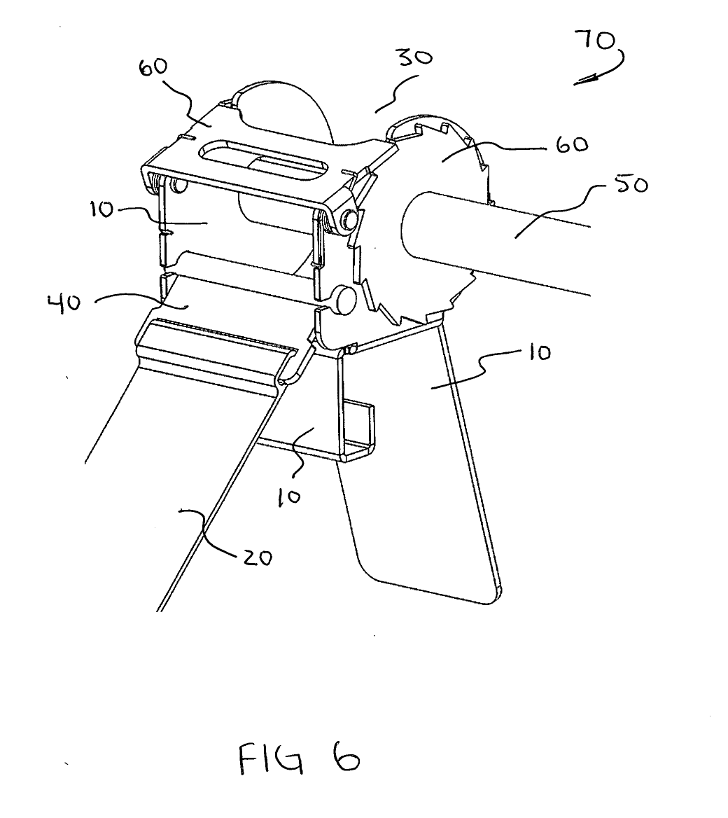

Referring to FIG. 5 and FIG. 6. the apparatus terminal buckle 40 offers redundant securement in the event the spooled cassette 30 tensioning member feature were ever to loosen the belt or strap member 20 in that the mating connection between the terminal buckle 40 and the locking/tightening mechanism 10 bracket requires an attachment path that must be articulated and therefore would not likely become dislodged from one another even if the tensioning belt or strap member 20 were to be loosened.

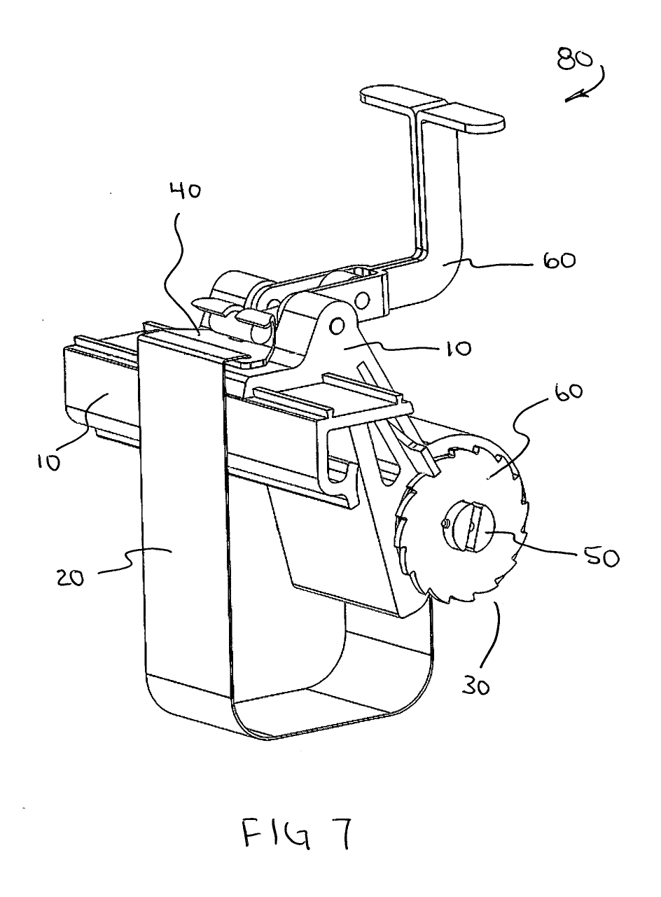

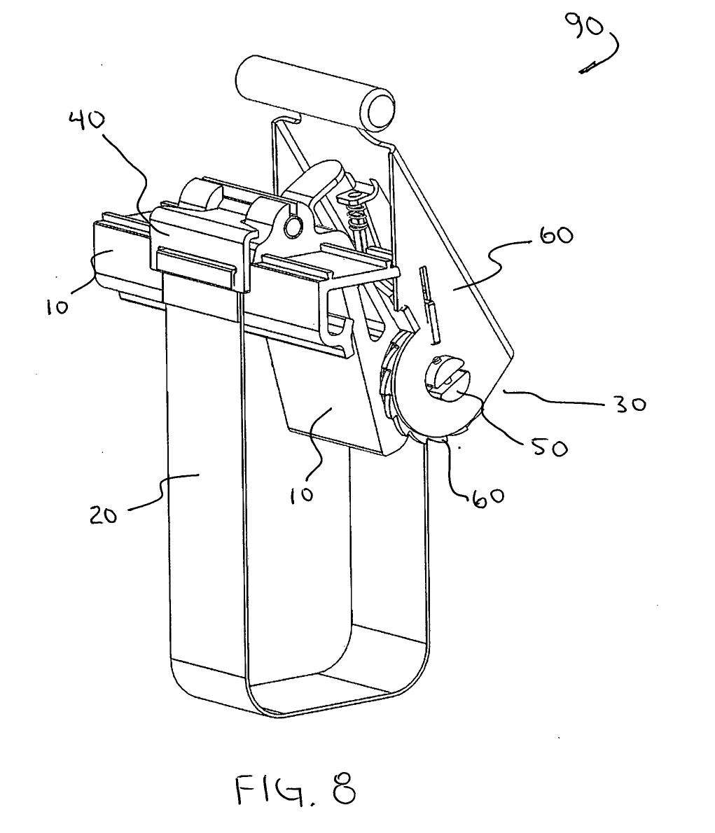

Construction of the various pieces and parts of the described apparatus can utilize various materials and construction techniques i.e. plastics, metal stamping, machined metal parts including machined metal or plastic extrusions based on cost and manufacturing economies along with a variety of fasteners i.e. rivets, screws, bolts etc. as depicted in FIG. 7 and FIG. 8 representing alternative apparatus configurations 80 and 90 respectively with their alternative progressive shaft spooling take up tightening device member 60 features.

This written description uses examples to describe and disclose the invention enabling a person skilled in the art to practice the invention including making and using these devices. The patentable scope of the invention is defined by the claims and may include other examples that may occur to those that are skilled in the art. Combinations of the described embodiments between apparatus configuration 70, 80, and 90 and the implied orientations and other examples are intended to be within the scope of these same claims based on their performance as described within this document and/or if they include equivalent component elements.

### DETAILED DESCRIPTION OF THE INVENTION

The Ladder Rack Belt is made up of three parts:
1. The Locking/Tightening Mechanism—is made up of a tensioning feature which is used to wind the belt or strap around a central cylinder and a unique bracket that is shaped to contour to the steps on ladders and position the belt under the rack cross rail before tightening. The mechanism provides a mistake proof female slot for inserting the Terminal Buckle at the end of the belt or strap.
2. The Belt or Strap—An adjustable length flexible member (fiber reinforced to withstand the force of an accident) used to encircle the ladder and the ladder rack cross rails to create an enclosed locking system
3. Terminal Buckle—is at the end of the strap and must be specially articulated to mate properly and securely with the locking/tightening mechanism. It fits uniquely into the locking/tightening mechanism since it has been shaped to enter in only one direction and thereby making it mistake proof. Whereby this entire process provides redundant safety in the transport of ladders.

1. The apparatus is comprised of a Locking/Tightening Mechanism that contains within that member a unique and co-forming bracket shape that is complementary to both Extension and Step Style Ladders in such a way to orient when applied the bracket member co-forming shape to the rail and step configuration. This also orients the Extension and Step Style Ladder members in only one way to be parallel to the primary transportation vehicle centerline. This apparatus also orients its contained flexible strap Belt member to pass underneath the vehicle overhead rack cross rail bar while resting on the uppermost rail and step configuration of Extension and Step Style Ladder members thereby serving as the origin and termination point to its Belt member

2. The Belt member is a flexible strap contained within the Locking/Tightening Mechanism and permanently affixed to the Locking/Tightening Mechanism rotating cylindrical member in such a way to provide for its storage when not in use or to collect the unneeded length of flexible strap during the actuation of tightening during the securement of Extension and Step Style Ladders to a vehicle overhead rack cross rail members prior to their transportation.

3. The Terminal Buckle at the final end of the Belt member allows for the connection at that end of the Belt member to return and become securely affixed to the Locking/Tightening Mechanism bracket from which it originated by articulating the Terminal Buckle to pass through a slotted aperture within the Locking/Tightening Mechanism bracket member to then to be moved an appropriate amount longitudinally before being rotated from that position in such a way that it is engaged to be ready to be tightened by the Locking/Tightening Mechanism rotating cylindrical member that carries the origin end of the Belt. The said Terminal Buckle most notably provides for a secondary securement technique in that even if the Locking/Tightening Mechanism were returned to its pre-tightened state the Terminal Buckle would not disconnect on its own from the slotted aperture within the Locking/Tightening Mechanism bracket as it would not be properly positioned to align with the said slotted aperture unless it was moved longitudinally to do so.
